(19) United States
(12) Patent Application Publication
(10) Pub. No.: US 2010/0268466 A1
(43) Pub. Date: Oct. 21, 2010

(54) ANTI-COLLISION SYSTEM FOR RAILWAYS

(76) Inventor: Velayutham Kadal Amutham, Perungudi (IN)

Correspondence Address: HARNESS, DICKEY & PIERCE, P.L.C., P.O. BOX 828, BLOOMFIELD HILLS, MI, 48303, US

(21) Appl. No.: 12/550,459

(22) Filed: Aug. 31, 2009

(30) Foreign Application Priority Data
Apr. 15, 2009 (IN) 864/CHE/2009

(51) Int. Cl. G08G 9/02; G08G 1/16

(52) U.S. Cl. 701/301

(57) ABSTRACT

An anti-collision system and method for railed vehicles are provided. This system can include a camera module, a processor, and a transceiver. The camera module is configured to record images of the environment around a first railed vehicle. The processor is configured to receive an image from the camera and extract a detected feature from the image. The detected feature is then compared to features stored in a database having an associated unique location on the rail system. Should the detected feature be found within the database, the unique location on the rail system is transmitted via a transmitter as the present location of the railed vehicle.

### CROSS-REFERENCE TO RELATED APPLICATIONS

This application claims the benefit and priority of India Application Serial No. 864/CHE/2009, filed Apr. 15, 2009. The entire disclosure of the above application is incorporated herein by reference.

### TECHNICAL FIELD

The present teachings relate to an anti-collision system for railed vehicles.

### BACKGROUND

The use of railed vehicles such as transit or transport trains will likely increase with population pressures and energy prices. The increased number of railed vehicles competing for fixed infrastructure resources such as rails lead to increases in transit system congestion. This increased competition for rail system resources further increases the possibility of system failures which may lead to trains being on the same rails while being in a close physical proximity. In these situations, when the two trains are traveling toward one another or one train has stopped, an accident may occur.

To avoid these situations, systems have been proposed which utilize a global positioning system or GPS to track the location of trains on a rail system. Unfortunately, GPS does not have the accuracy necessary to determine which of the pair of parallel tracks on which a train was traveling. Because of this and other reasons, GPS only based systems do not provide a cost effective solution to the issues presented.

### SUMMARY

According to the present teachings, an anti-collision system for railed vehicles is provided. This system can include a camera module, a processor, a receiver, and a transmitter. The camera module is configured to record images of the environment around a first moving railed vehicle. The processor is configured to receive an image from the camera and extract a detected feature from the image. The detected feature is compared to features stored in a database. Each feature stored in the database has an associated unique location on the rail system. Should the detected feature be found within the database, the unique location on the rail system is transmitted via a transmitter as the present location of the railed vehicle. The receiver monitors signals transmitted by other railed vehicles. These received signals are used by the processor to determine if another railed vehicle represents a threat to the first railed vehicle.

The detected feature of the image can include at least one of a color, a numerical symbol, a barcode, or a known landmark such as a tunnel entrance. The processor module has a memory and a stored database of image features. The stored image features include associated therewith unique location information which may be indicative of an entire length of rail or a specific unique location on a specific section of rail.

In other teachings, a method is provided which comprises recording an image of an environment around a first railed vehicle. Detected feature data is extracted from the image of the environment. This detected feature data is compared with a set of feature data having associated location information which is stored in a data structure. Should there be a match between the detected feature data and the set of feature data, the location information, vehicle identification, and velocity information for the railed vehicle is transmitted via a transceiver.

In another teaching, the method further comprises receiving locational information from a second railed vehicle. This location and velocity information is compared with location and velocity information associated the first railed vehicle by the processor. The processor then determines if a warning should be issued or if the brakes on the railed vehicle should be applied.

In still other teachings, an anti-collision system and methods described above are implemented by a computer or executed by one or more processors. This computer is coupled to a digital modem which is coupled to one of a transmitter, a receiver, or a transceiver for the transmission or receipt of the system associated signals. The anti-collision system is configured to calculate the potential risk vehicles pose to one another and perform a predetermined task upon reaching a predetermined level of risk.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of multiple railed vehicles using the system according to the present teachings;

FIG. 2 is an anti-collision system shown on the railed vehicle of FIG. 1;

FIG. 3 shows a flowchart describing the functioning of the system shown in FIG. 1;

FIG. 4 shows a flowchart representing the interaction of two systems shown in FIG. 2; and

FIG. 5 shows a flowchart representing the use of the system shown in FIG. 2 with a receiver at a fixed location.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

### EXAMPLES

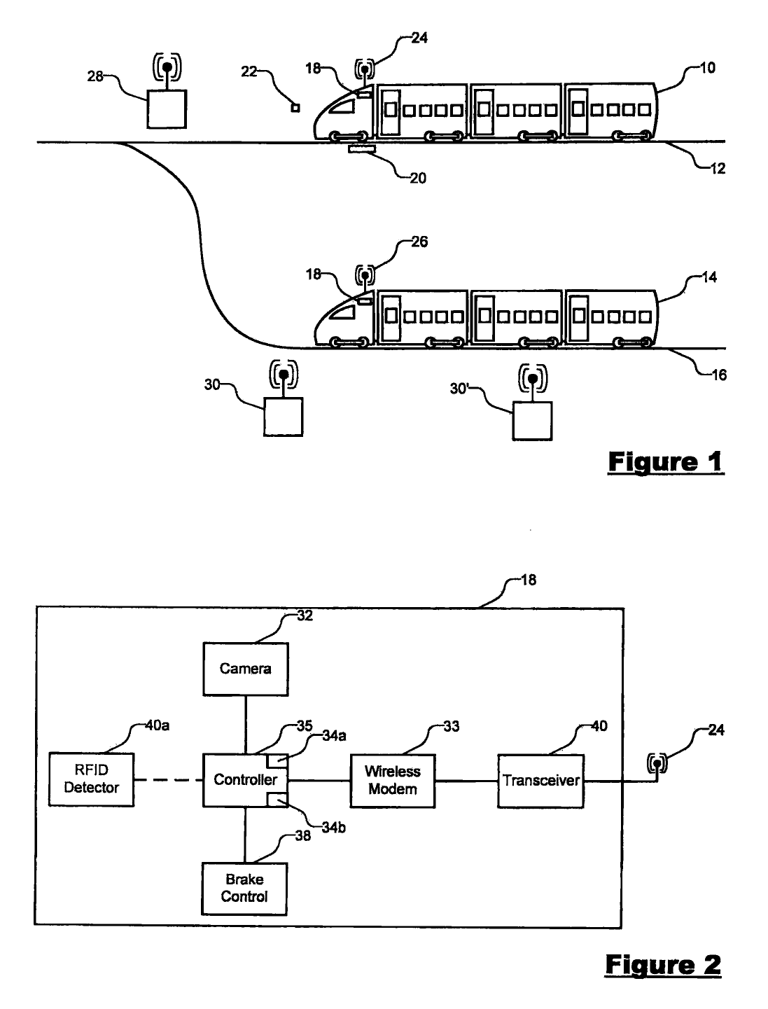

With reference to FIG. 1, an anti-collision system according to the present teachings is shown. The anti-collision system can be employed with one or more railed vehicles 10, 14, which can be located on one or more railway tracks 12, 16. The anti-collision system 18 can determine, by observing the environment around the railed vehicle 10, 14, the location of the railed vehicle 10, 14 within a rail system. This location along with vehicle identification and velocity information can then be transmitted to other railed vehicles or fixed locations 28, 30 within a predetermined operable range. This location information can then be used by the system to perform other tasks such as signaling, switching, or collision avoidance.

The anti-collision system 18 can be positioned at any desired location relative to the railed vehicles 10, 14, and optionally can be associated with an illuminating light on the front of the railed vehicle 10, 14. In one example, the anti-collision system 18 can be positioned so as to read images on illuminated posted signs along the rail route. In another example, the anti-collision system can be positioned so as to read images located between rails. The anti-collision system 18 is configured to detect a visual symbol 20 within the image or detect an active or passive RFID 22 near the rail, and to provide a wireless signal indicative of the location, velocity, and vehicle identification of the first railed vehicle 10 on the track 12.

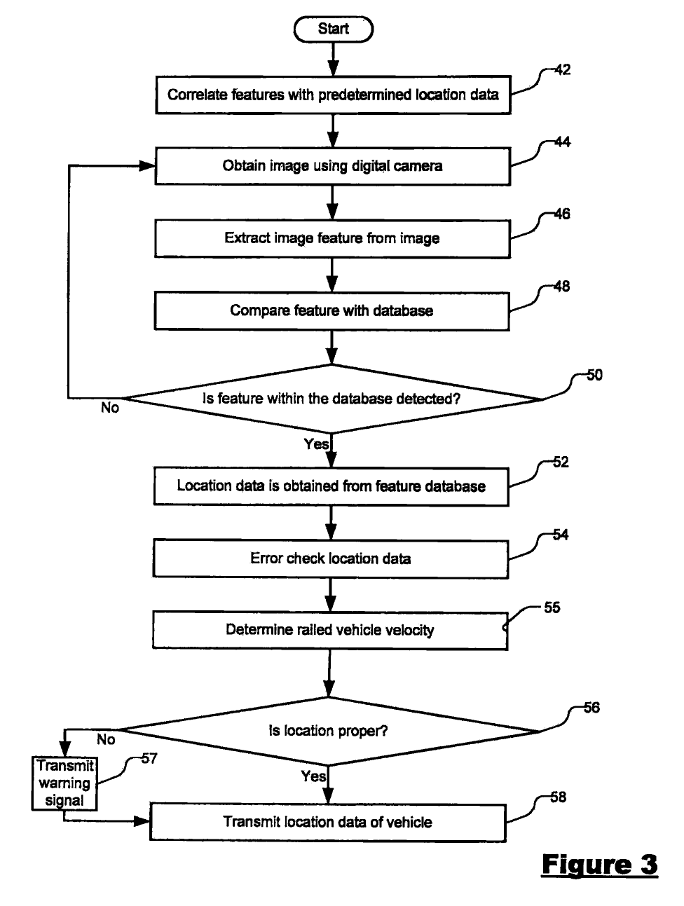

Generally, with reference to FIG. 2, each of the anti-collision systems 18 can include one or more processors 34a with one or more data storage devices 34b. As can be appreciated, the processors 34a can comprise one or more processing elements capable of implementing a control module 35. At least one of the data storage devices 34b can store one or more instructions contained in a control system associated with the control module 35. In one example, the storage device 34b can be at least one of Random Access Memory (RAM), Read Only Memory (ROM), a cache, a stack, or the like which may temporarily or permanently store electronic data.

Associated with the controller 35 can be an imaging system in the form of a CCD (charged coupled device) or CMOS based digital camera 32 which is configured to obtain images of the environment surrounding the railed vehicle 10. The processor 34a receives images from the camera 32 and by using machine vision techniques, examines the images for detected features. In this regard, a digital image is stored in the storage device 34b. The processor 34a runs a series of algorithms to separate the image into image components. The processor 34a then can analyze these segregated image components to determine if they match the images stored in the database. This analysis can include, for example, relative spacing, size, position, aspect ratio, and centroid location. It is envisioned the processor 34a can additionally receive an input of or can calculate the velocity of the railed vehicle. Optionally, the controller 35 can take inputs from an RFID reader 22 associated with a specific location.

Within the storage device 34b is a database of stored features and associated fixed geographical locations. The processor 34a will compare the detected feature with the features stored in the database. Should a match be found, the processor 34a can transmit a signal indicative of the location data, vehicle velocity, and vehicle identification through the wireless modem to the transmitter of the transceiver for transmission as a RF signal.

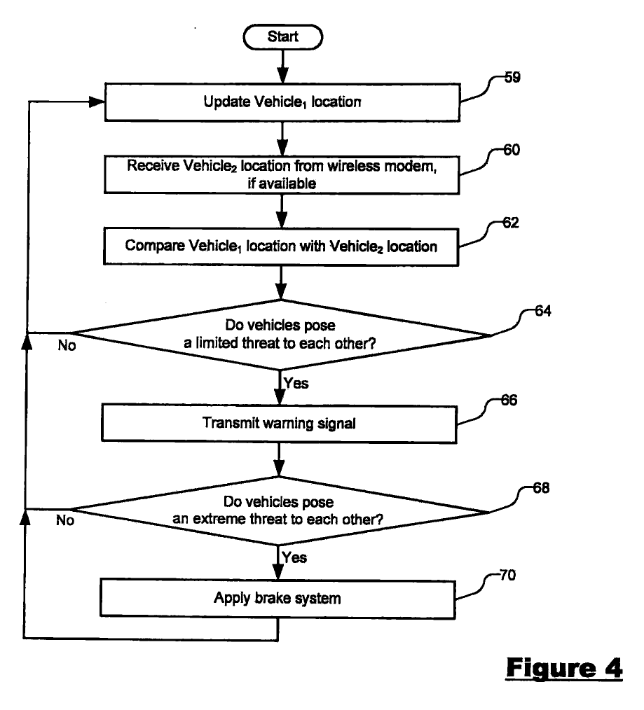

With reference to FIG. 3, a dataflow diagram illustrates the control system that can be embedded within control module 35. Various embodiments of the control system according to the present disclosure can include any number of sub-modules embedded within the controller module 35. The sub-modules shown may be combined and/or further associated to similarly determine when to transmit a signal, initiate a warning or alarm, or apply the railed vehicle's brake system. In various embodiments, the control module 35 can include the memory 34b, transceiver 40, and/or imaging system 32.

Prior to the initiation of the system, the memory 34b is populated in block 42 with feature data and associated location information from an entire railway system. This feature data may include, but is not limited to colors, alphanumeric values, symbols, and/or barcodes. The location information may be indicative of a specific coordinate location in space or may be indicative of a specific rail line. For example, location information may indicate a railed vehicle has entered a specific curve of a rail line, or may only indicate that the railed vehicle is on a line designated, for example, as “the red line.”

In block 44, an image is obtained by camera, optical sensor, or imaging system 32. By associating the camera 32 with the railed vehicle's forward illuminating light, the camera can take images of the environment surrounding the railed vehicle 10 in the day or night. In this regard, it is envisioned a forward directed camera 32 would be able to obtain images of signs containing features to be extracted. Additionally, features such as colors or symbols may be detectable on signs or between rails. It is envisioned that naturally occurring features such as tunnel entrances or bridges can also be detected by the imaging system 32.

In block 46, features are extracted from the image using known machine vision techniques. In this regard, it is envisioned the processor could be able to read barcode and/or associated color shape information. This information is extracted from the image and then compared with feature data stored in the data structure of storage 34b.

In query block 50, a determination is made if one of the features within the database is detected or can be correlated. In the event no correlation is found, the system returns to obtaining and processing images. Should a correlation be found in query block 50, the processor 34a obtains location information from the database in storage 34b, associated with the feature. This feature data and location data can then be error checked against a railed vehicle manifest to ensure the railed vehicle 10, 14 is located in an appropriate position. If the location is not proper, such as not on time or on the wrong track, the system can issue a warning signal.

The railed vehicle 10 location, velocity, and identification can then be transmitted through the wireless modem 33 and the transceiver 40 which produce a RF signal representing the first railed vehicle location. It is envisioned the system will transmit a signal 24, 26 which can be received up to about 10 km away. For safety reasons, this signal can be coded or encrypted using known methods such as, but not limited to Frequency Division Multiplexing, Wave Division Multiplexing, Time Division Multiplexing, Pulse Code Modulation, Delta Modulation, Non-Return-to-Zero-Code, Bi-phase Codes, and Mancester encoding.

With reference to FIG. 4, a flowchart diagram illustrates a method performed by the system at block 58. The first railed vehicle 10 updates its location as described above by determining its location and by storing a value indicative of its present location. In block 60, the first vehicle receives the location of a second railed vehicle through the transceiver 40 and wireless modem 33.

The locations of the first and second railed vehicles are compared in block 62 by the processor 34a. In query block 64, the system determines if the first and second railed vehicles pose a limited threat to each other. In this regard, the processor 34a is configured to calculate the potential risk vehicles pose to one another and perform a predetermined task upon reaching a predetermined level of risk. This determination can be made by evaluating the vehicles' locations and velocities. Should they pose a limited threat, a warning is transmitted to the operator of the first railed vehicle 10. Optionally, a warning can be transmitted to the operator of the second railed vehicle.

Vehicles can be deemed to pose a limited risk to each other if they are on the same track, but are a predetermined distance apart. Similarly, trains can be deemed a limited risk if they are traveling in the same direction along the same section of track. In query block 68, the system determines if the vehicles 10, 14 pose a significant threat to each other. In the event they do, the system will transmit a warning and apply the brake system to stop the railed vehicle.

By way of non-limiting example, extreme threats can include times when one railed vehicle is within a predetermined distance of another railed vehicle and on the same track. Additional scenarios include when one railed vehicle is not moving at a location and another railed vehicle is approaching. In these circumstances, velocity information can be used to calculate estimated times of interaction.

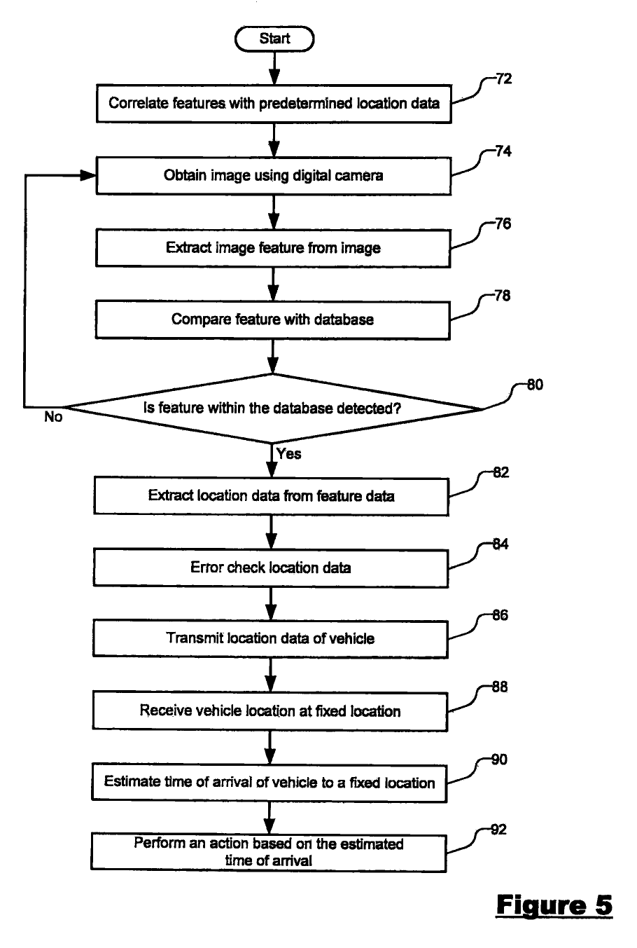

With reference to FIG. 5, a flowchart diagram illustrates an alternate method performed by the system. In this regard, FIG. 5 represents the interaction of one or more railed vehicles with a fixed location such as a switching station 28 or passenger terminal 30. It is envisioned the steps of FIGS. 4 and 5 can be performed simultaneously.

As described above with respect to FIG. 3, system 18 will determine the location of the first railed vehicle within a rail system (blocks 72-84). In block 84, this location data can be error checked by comparing the measured location with expected location data. The expected location can be calculated from previously determined locations as well as velocity information for the railed vehicle. Location, vehicle identification, and velocity information can now be transmitted through the transceiver 40 to receivers at fixed locations 28, 30 (see FIG. 1). Using this information, controllers 35 at the fixed location can calculate an estimated time of arrival of the railed vehicle to a fixed location 28, 30. In this regard, these fixed locations can be a switch or a passenger terminal. As often times railed vehicles travel through mountainous terrains, it is envisioned a series of repeater stations 30′ can be positioned along a rail at predetermined intervals to transmit the location of the railed vehicle 10. The controllers 35 at the fixed location can then take action, such as switching rails, displaying an estimated arrival time, or transmitting warning signals to other railed vehicles.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of preventing a collision between a first and a second railed vehicle, the method comprising:
taking a first image of an environment adjacent to the railed vehicle;
extracting at least one feature from the first image;
comparing the at least one feature with a plurality of features within a feature database to determine if there is a correlation between the at least one feature and at least one of the plurality of features within a feature database; and
if there is a correlation between the extracted feature and the at least one of the plurality of features within a feature database, assigning a location data to the first railed vehicle.

2. The method of claim 1, wherein assigning a location data to the first railed vehicle is assigning location data previously associated with the at least one of the plurality of features within the feature database.

3. The method of claim 1, further comprising:
transmitting the location data of the first railed vehicle via a wireless signal.

4. The method of claim 3, further comprising:
calculating a velocity of the first railed vehicle and transmitting the velocity via a wireless signal.

5. The method of claim 3, further comprising:
receiving the wireless signal containing the location data; and
calculating a risk of an accident based on the location data.

6. The method of claim 5, further comprising:
performing an action based on the calculated risk of an accident.

7. The method according to claim 6, wherein taking an action based on the calculated risk is one of initiating a warning and applying a brake.

8. The method according to claim 3 further comprising:
calculating a distance between a predetermined location and the first railed vehicle.

9. The method according to claim 8 wherein calculating a distance between a predetermined location and the first railed vehicle is calculating the distance between the first railed vehicle and the second railed vehicle.

10. The method according to claim 3 further comprising:
calculating an estimated time of arrival of the first railed vehicle to a predetermined location.

11. A system for preventing the collision of a first and a second railed vehicle, the system comprising:
a processor;
a transmitter coupled to the processor; and
a camera module configured to record images of an environment around the first railed vehicle, wherein the processor is configured to receive an image from the camera module and extract a detected feature from the image, said processor being further configured to compare the detected feature to features stored in a database and assign an associated location data to the first railed vehicle if a correlation exists between the extracted feature and at least one of the features stored in the database.

12. The system according to claim 11, wherein each feature stored in the database has an associated one of a plurality of locations on the rail system.

13. The system according to claim 12, wherein the transmitter transmits the associated location data.

14. The system according to claim 11, further comprising a receiver which monitors signals transmitted by the second railed vehicle.

15. The system according to claim 14, wherein the processor is configured receive the signals transmitted by the second railed vehicle and to calculate a probability if the second railed vehicle represents a threat to the first railed vehicle.

16. The system according to claim 11, wherein the detected feature comprises at least one of a color, an alphanumeric symbol, a barcode, and a known landmark.

17. The system according to claim 11, wherein the processor module comprises a memory and a stored database of image features.

18. The system according to claim 11, wherein the features stored include associated therewith unique location information indicative of one of an entire length of rail or a specific unique location on a specific section of rail.

19. The system according to claim 11, wherein said second railed vehicle comprises:
a second processor;
a second transmitter; and
a second camera module configured to record images of an environment around the second railed vehicle, wherein the second processor is configured to receive a second image from the second camera module and extract a second detected feature from the second image, said second processor being further configured to compare the second detected feature to features stored in a second database and assign an associated second location data to the second vehicle if a correlation between the extracted feature and at least one of the features stored in the second database.

20. The system according to claim 19, wherein the second transmitter transmits the associated second location data.
